(19) United States
(12) Patent Application Publication
(10) Pub. No.: US 2016/0146421 A1
(43) Pub. Date: May 26, 2016

(54) Lighting apparatus for a vehicle with a fan

(71) Applicant: Hella KGaA Hueck & Co., Lippstadt (DE)

(72) Inventor: Giuseppe Mattina, Lippstadt (DE)

(21) Appl. No.: 14/876,323

(22) Filed: Oct. 6, 2015

(30) Foreign Application Priority Data
Nov. 26, 2014 (DE) 102014117320.1

(51) Int. Cl. F21S 8/10

(52) U.S. Cl. CPC F21S 48/325

(57) ABSTRACT

A lighting apparatus for a vehicle, with a housing that holds a fan. An air conduction section is provided, through which an air flow that can be created in the housing with the fan can be conducted. The fan has a service opening through which the fan can be removed from the housing. According to the invention, the air conduction section is designed as one piece with the housing and is arranged upstream of the service opening.

### CROSS REFERENCE

This application claims priority to German Application No. 10 2014 117320.1, filed Nov. 26, 2014, which is hereby incorporated by reference.

### FIELD OF TECHNOLOGY

The present invention pertains to a lighting apparatus for a vehicle, specifically a headlamp with a housing that holds a fan and wherein an air conduction section is provided that can be used to conduct an air current that can be generated using the fan and wherein the housing has a service opening through which the fan can be re-moved from the housing.

### BACKGROUND

FIG. 1 shows a lighting apparatus using the example of a headlamp in accordance with the state of the art, and the headlamp has a roughly pot-shaped housing 10 that holds light modules with semiconductor luminous elements and the semi-conductor luminous elements are cooled by an active fan. For this purpose, as an example, a heat sink 19 is displayed in the housing that can hold one or more semiconductor luminous elements. To dissipate the heat from these via the heat sink 19, the fan 11 is used, which is shown in a non-mounted arrangement in conjunction with an air conduction section 12 and a sealing element 20. If the fan 11 is installed in the area of a service opening 13 made in the housing 10, by operating the fan 11, an air flow can be generated that passes through the air conduction section 12 and blows on the heat sink 19. To generate a secondary air flow, the air conduction section 12 also has a secondary air conduction opening 18, such as for generating air circulation in the housing 10 of the headlamp.

The fan 11 has a fan frame with a roughly ring-shaped fan frame 21, and the fan frame 21 contains a rotating fan wheel 22 and the fan wheel 22 can be made to rotate using a motor (not shown).

In the installed arrangement, the air conduction section 12 is located between the cooling section 19 and the fan 11, wherein the fan 11 is attached at the rear of the air conduction section 12. For this purpose, the air conduction section 12 is installed in the housing 10 of the headlamp, and subsequently, the fan 11 can be installed on the air conduction section 12. The fan 11 along with the air conduction section 12 overlaps with the service opening 13, which can be sealed off on the side using the sealing element 20. In case of repair, for example if it is necessary to replace the fan 11, the sealing element 20 can be opened, and the fan 11 can be detached from the air conduction section 12 through the service opening 13, for example to replace it.

EP 2 327 928 A1 shows a lighting apparatus using a headlamp as an example, and a service opening is shown in the rear of the housing of the headlamp. In the area of the service opening, there is a fan installed in the housing of the headlamp via a holding frame. The holding frame has a roughly ring-shaped design and can also take on air conduction tasks. The fan is first attached to the holding frame and can then be installed in the headlamp together with the holding frame. In case of service, such as a defect in the fan, the fan can be removed from the holding frame, and a replacement fan be refastened to the holding frame. Then, the service opening shown can be closed again.

The arrangement familiar from the state of the art and the mounting of a fan in the housing of a lighting apparatus basically require another component that holds the fan in the housing and takes over the air conduction task. In any case, the holding component must be configured in such a way that enables air to flow through primarily in the center, particularly because fans for use in lighting apparatus are usually designed as axial fans. A disadvantage is the necessity of a component that is required primarily only to hold the fan and for air conduction.

### SUMMARY OF THE INVENTION

The task of the invention is the advanced embodiment of a lighting apparatus with an improved mount for a fan in the housing of the lighting apparatus. In particular, the fan is to be removable through a service opening in the housing of the lighting apparatus and the number of necessary components of the lighting apparatus is to be further reduced.

The invention includes the technical contribution wherein the air conduction section is embodied as one piece with the housing and is arranged on the inside in front of the service opening.

The invention is based on the principle that the air conduction section required for air conduction is to be embodied as one piece with the housing of the lighting apparatus, wherein the air conduction section is arranged as a molded recess or detailed geometric embodiment in the housing body itself. The housing is normally manufactured of plastic as an injection molded component and the air conduction section can be manufactured particularly advantageously as one piece with the housing in a shared injection molding process. This provides the benefit that the air conduction section does not have to be provided as a single component, and the air conduction section does not first have to be installed on the housing. The design of the air conduction section as part of the housing body is specifically enabled by the fact that the air conduction section is arranged upstream of the service opening. The service opening forms an opening area in the rear section of the housing, and the end face of the housing is interrupted in the area of the service opening. If the air conduction section is upstream of the service opening, a possible injection molding configuration is provided by the fact that no double end faces or undercuts are formed, ensuring easy demolding of the plastic housing body from an injection mold. Normally, the service opening can be sealed off by a sealing element in the typical manner.

The air conduction section can be arranged particularly advantageously to over-lap with the service opening so that the fan arranged on the air conduction section can be removed from the air conduction section through the service opening. Especially for repair measures, the fan must be arranged in the lighting apparatus such that it is replaceable, and the additional advantage of replacability results specifically from the arrangement of the air conduction section upstream of the service opening so that the fan can be arranged immediately upstream of the service opening, allowing it to be removed.

In another advantageous embodiment, the air conduction section can have a roughly ring-shaped design, and the ring-shaped base body of the air conduction section can have an air conduction opening, wherein the fan can be arranged on the side of the air conduction section that faces the service opening. Thus the fan is held by the air conduction section and can be easily reached through the service opening. The fan can have a fan frame that likewise has a ring-shaped design and the ring-shaped body of the air conduction section can also have advantageous matching geometric features to the fan frame with a ring-shaped design.

For example, the air conduction section can be arranged on the housing via stay bars. There may be air passage openings between the stay bars so that air taken in by the fan can reach the area between the service opening or the sealing element seated in the service opening and the fan.

The service opening can form an opening edge in the frame, wherein the stay bars are connected to the housing on or in the area of the opening edge. The roughly ring-shaped air conduction section is thus held by the stay bars in approximately the middle of the service opening, wherein the stay bars are tapered such that the air conduction section is not seated in the service opening itself, but instead the air conduction section protrudes at least a certain distance into the housing of the lighting apparatus and the sealing element can also be inserted into the opening edge of the service opening.

The air conduction section has an air conduction opening that is primarily formed centered through the ring-shaped base body of the air conduction section. A heat sink can be arranged on the interior of the housing of the lighting apparatus, with the heat sink connected to the air conduction section. The air flow generated by the fan through the air conduction section thus blows on the heat sink and can dissipate heat from the semiconductor luminous elements arranged on the heat sink. In addition, the air conduction section can have a secondary air conduction opening through which an air flow of the fan can be conducted, in addition to the air flow through the central air conduction opening. The air flow that reaches the housing of the headlamp through the secondary air conduction opening can help to circulate air in the housing, which is particularly necessary to prevent local heat accumulation and, given corresponding weather conditions, to remove condensation from the cover lens.

The fan can be fastened to the air conduction section using fastening elements such as screw fasteners, bolts, rivets or other connecting elements. The fastening elements have the advantage of being reached and unscrewed from the service opening for easy disconnection of the fan from the air conduction section.

The stay bars for connection between the air conduction section and the opening edge of the service opening can also be formed by a perforated grille or the like so that the air conduction section can also be held securely on the housing; at the same time, it can be ensured that air can pass through the holder between the air conduction section and the housing.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is an overhead view of a lighting apparatus with a fan and an air conduction section in accordance with the prior art.

FIG. 2 is a view of the arrangement of the air conduction section in the housing of the lighting apparatus, wherein the view shows the area of the service opening from the interior of the housing.

### DETAILED DESCRIPTION OF THE DRAWINGS

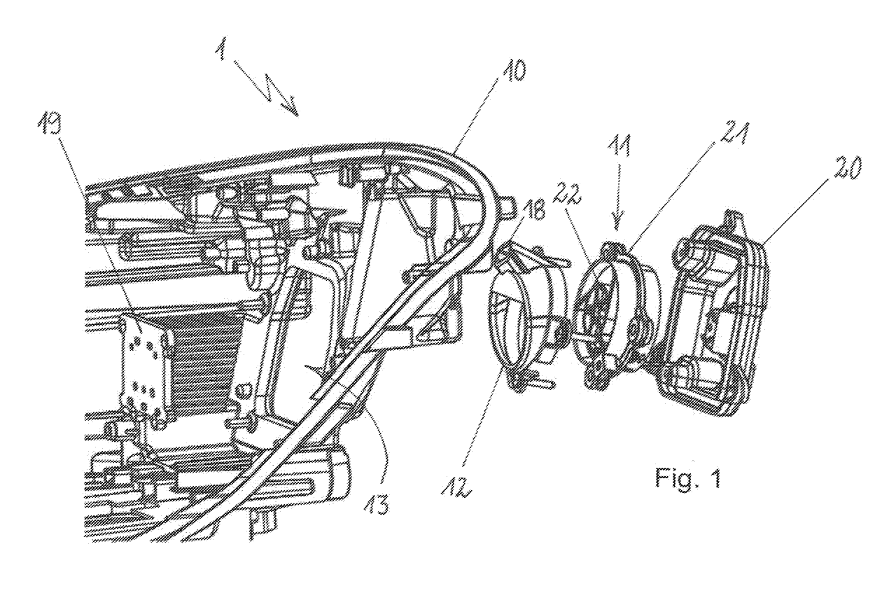

The overhead view of the lighting apparatus 1 shown in FIG. 1 shows the state of the art and has already been described in the introductory section of the present description.

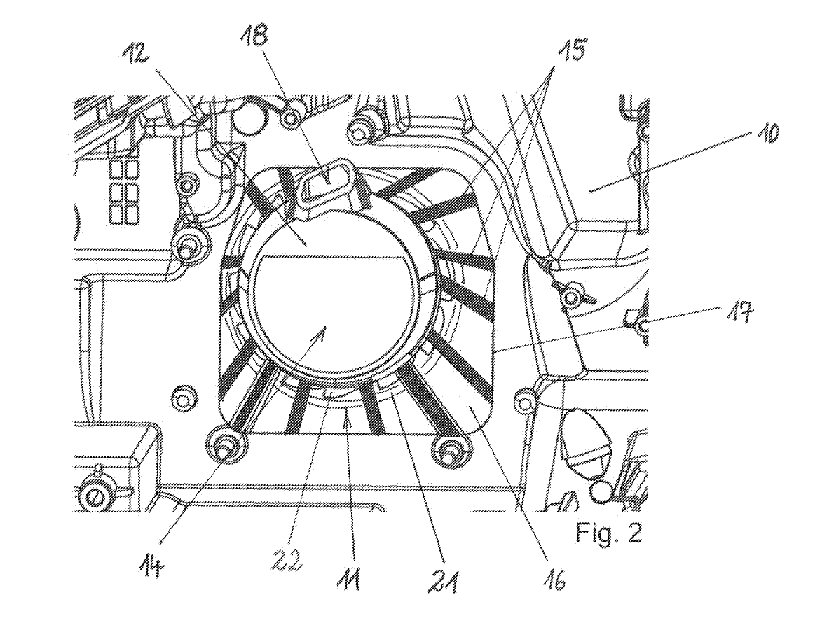

FIG. 2 contains an illustration of the housing 10 of the lighting apparatus 1 in detail in accordance with FIG. 1, as seen from the interior of the housing 10 towards a service opening 13 made in the housing 10. The service opening 13 can be sealed off using a sealing element 20, as shown in FIG. 1, from the outside of the housing 10. The area of the service opening 13 has an air conduction section 12 with a fan 11 arranged on the rear section. Thus the fan 11 is pointed towards the outside of the service opening 13 and can be removed from the air conduction section 12, for example for installation and/or repair.

The air conduction section 12 primarily has a roughly ring-shaped design and has an air conduction opening 14 through which an air flow, which can be generated while operating fan 11, passes and can blow on a heat sink as shown in FIG. 1, for example. In addition, the air conduction section 12 has a secondary air conduction opening 18 that likewise permits passage of an air flow that is generated during operation of fan 11; the air flow passing through the secondary air conduction opening 18 can cause an air circulation in the housing 10 of the lighting apparatus.

The service opening 13 is shown with a surrounding opening edge 17, and between the air conduction section 12 and the opening edge 17, there are stay bars 15, and between the stay bars 15, there are air conduction openings 16. If the fan 11 is put into operation, air can pass through the air passage openings 16 and reach the area behind the air conduction section 12 and behind the fan 11 and finally be aspirated by the fan 11 so that an air flow can be generated through the air conduction opening 14 and through the secondary air conduction opening 18. The stay bars 15 begin approximately in the area of the opening edge 17 and extend inwards radially towards the air conduction section 12. Through the stay bars 15, the air conduction section 12 can be produced along with the housing 10 as a single piece out of a uniform material in an injection molding process so that the air conduction section 12 does not have to be provided as a single component.

The fastening of the fan 11 on the rear side of the air conduction section 12 is not shown in greater detail here and can include fastening elements that take the form of screw fasteners, for example. Removing the sealing element from the service opening 13 from the outside enables direct access to the fan 11 so that the fan 11 can be removed from the air conduction section 12 without removing the same. Thus the air conduction section 12 also serves as a fixture for securely holding the fan 11 in the housing 10.

In its execution, the invention does not relate solely to the preferred design example described above. On the contrary, a number of variants that use the solution as represented above are conceivable, even on designs that are fundamentally different. All characteristics resulting from the claims, the description or the drawings and/or advantages, including design details, or physical arrangements and process steps can be essential for the invention on their own as well as in any combination.

### LIST OF REFERENCE SYMBOLS

1 Lighting apparatus
10 Housing
11 Fan
12 Air conduction section
13 Service opening
14 Air conduction opening
15 Stay bar
16 Air passage opening
17 Opening edge
18 Secondary air conduction opening
19 Heat sink
20 Sealing element
21 Fan frame
22 Fan wheel

1. A lighting apparatus for a vehicle comprising:
a housing holding a fan,
an air conduction section integral with the housing, wherein said air conduction section conducts an air stream generated by the fan in the housing,
wherein the housing has a service opening through which the fan can be removed from the housing,
wherein the air conduction section is arranged on the inside of the service opening (13).

2. The lighting apparatus in accordance with claim 1, wherein by the fan is held by the air conduction section.

3. The lighting apparatus in accordance with claim 1 wherein the air conduction section is arranged to overlap with the service opening such that the fan located on the air conduction section can be removed from the air conduction section through the service opening.

4. The lighting apparatus in accordance with claim 1 wherein the air conduction section is roughly ring-shaped and in which an air conduction opening is formed, wherein the fan is located on the side of the air conduction section that faces the service opening.

5. The lighting apparatus in accordance with claim 1 wherein the air conduction section is positioned on the housing using stay bars.

6. The lighting apparatus in accordance with claim 5, wherein air passage openings are formed between the stay bars (15).

7. The lighting apparatus in accordance with claim 5 wherein the service opening has an opening edge in the housing, wherein the stay bars are connected to the housing at or in the area of the opening edge.

8. The lighting apparatus in accordance with claim 1 wherein the air conduction section is manufactured as one piece with the housing in an injection molding process.

9. The lighting apparatus in accordance with claim 1 wherein the air conduction section has a secondary air conduction opening through which an air flow from the fan can be conducted in addition to the air flow through the air conduction opening.

10. The lighting apparatus in accordance with claim 1 wherein the fan is fastened to the air conduction section with screw elements.
